(19) United States
(12) Patent Application Publication
(10) Pub. No.: US 2026/0143336 A1
(43) Pub. Date: May 21, 2026

(54) ASSOCIATION IDENTIFIER (AID) ASSIGNMENT FEEDBACK FOR STATIONS

(71) Applicant: Cisco Technology, Inc., San Jose, CA (US)

(72) Inventors: Domenico FICARA, Essertines-Sur-Yverdon (CH); Federico LOVISON, Fontanelle (IT); Ugo M. CAMPIGLIO, Morges (CH); Javier I. CONTRERAS ALBESA, Sant Cugat del Valles (ES); Jerome HENRY, Pittsboro, NC (US)

(21) Appl. No.: 19/186,524

(22) Filed: Apr. 22, 2025

Related U.S. Application Data
(60) Provisional application No. 63/722,365, filed on Nov. 19, 2024.
(60) Provisional application No. 63/735,205, filed on Dec. 17, 2024.

(51) Int. Cl. H04W 12/02; H04W 12/76; H04W 76/10

(52) U.S. Cl. CPC H04W 12/02; H04W 12/76; H04W 76/10

(57) ABSTRACT

The present disclosure provides techniques for APs to evaluate status updates received from STAs for adaptive AID management. An AP establishes a wireless communications link with a station, generates a list of N AIDs, each of the N AIDs to be used in a corresponding epoch of N epochs associated with an EDP group, transmits to the station in a protected wireless frame, information indicating the list of N AIDs for the station, receives from the station a response frame to the protected wireless frame, where the response frame includes a status code indicating whether the station successfully stored at least a portion of the list of N AIDs, and maintains the wireless communications link with the station based at least in part on the timing information for randomized MAC address rotation for the EDP group, and including using each AID in the list of N AIDs during corresponding epochs.

### CROSS-REFERENCE TO RELATED APPLICATIONS

This application claims benefit of co-pending U.S. provisional patent application Ser. No. 63/722,365 filed Nov. 19, 2024 and co-pending U.S. provisional patent application Ser. No. 63/735,205 filed Dec. 17, 2024. The aforementioned related patent applications are herein incorporated by reference in their entirety.

### TECHNICAL FIELD

Embodiments presented in this disclosure generally relate to wireless communication. More specifically, embodiments disclosed herein relate to non-access point (AP) devices evaluating assigned association identifiers (AIDs) and providing feedback to associated APs for adaptive AID management in enhanced data privacy (EDP) operations.

### BACKGROUND

Wireless communication networks, such as Wi-Fi, rely on various identifiers to manage device connections and communications. However, malicious attackers may exploit these identifiers, such as Media Access Control (MAC) addresses, Association Identifiers (AIDs), and sequence numbers, to track device activity over time. By observing these parameters in transmitted frames, an attacker can correlate packets to a specific device, even as it moves across different access points (APs), leading to potential user tracking and privacy breaches. To address this issue, enhanced data privacy (EDP) mechanisms is used to periodically modify these identifiers to prevent long-term tracking. EDP involves dynamically updating these parameters, such as AIDs, MAC addresses, sequence numbers (SN), and packet numbers (PN), at defined epochs to anonymize a device's identity. Such periodic identifier change makes it much harder for attackers to associate new transmissions with a previously observed device.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example AID assignment frame sent from an AP to a STA, according to some embodiments of the present disclosure.

FIGS. 2A-2D depict example AID assignment response frames sent from a STA to an AP, each indicating a different status code, according to some embodiments of the present disclosure.

FIG. 3 depicts an example AID assignment request frame sent from a STA to an AP, reporting the STA's storage capacity and preferred advance notice for AID updates, according to some embodiments of the present disclosure.

FIG. 4A depicts an example EDP group parameter frame sent from an AP to a STA, advertising different EDP groups and their associated parameters, according to some embodiments of the present disclosure.

FIG. 4B depicts an example EDP epoch request frame sent from a STA to an AP, requesting to join an EDP group, according to some embodiments of the present disclosure.

FIG. 4C depicts an example EDP epoch response frame sent from an AP to a STA, indicating the status of the STA's request to join an EDP group, according to some embodiments of the present disclosure.

FIG. 5 depicts an example EDP epoch reassignment frame sent from an AP to a STA, assigning the STA to another EDP group, according to some embodiments of the present disclosure.

FIG. 6 depicts an example method for a STA joining an EDP group, according to some embodiments of the present disclosure.

FIG. 7 depicts an example method for a STA receiving and storing an AID list, according to some embodiments of the present disclosure.

FIG. 8 is a flow diagram depicting an example method of a STA receiving, evaluating, and responding to an AID assignment from an AP, according to some embodiments of the present disclosure.

FIG. 9 depicts an example client device configured to perform various aspects of the present disclosure, according to some aspects of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, including establishing, by a wireless access point (AP), a wireless communications link between the AP and a wireless station, where establishing the wireless communications link comprises assigning the wireless station to an Enhanced Data Privacy (EDP) group, the EDP group associated with timing information for rotating wireless frame anonymization parameters at epoch transitions; generating, by the AP, a list of N association identifiers (AIDs) for the wireless station, each of the N AIDs to be used in a corresponding epoch of N epochs associated with the EDP group; transmitting to the wireless station in a protected wireless frame, information indicating the list of N AIDs for the wireless station; receiving from the wireless station a response frame to the protected wireless frame, where the response frame includes a status code indicating whether the wireless station successfully stored at least a portion of the list of N AIDs; and maintaining, by the AP, the wireless communications link with the wireless station based at least in part on the timing information for randomized MAC address rotation for the EDP group, and including using each AID in the list of N AIDs during corresponding epochs.

Other embodiments in this disclosure provide one or more non-transitory computer-readable media containing, in any combination, computer program code that, when executed by operation of a computer system, performs operations in accordance with one or more of the above methods, as well as a system of a network device comprising one or more computer processors, and one or more memories collectively containing one or more programs, which, when executed by the one or more computer processors, perform operations in accordance with one or more of the above methods.

### EXAMPLE EMBODIMENTS

Enhanced Data Privacy (EDP) has been introduced to prevent attackers from tracking devices based on fixed identifiers commonly used in wireless communication networks. Attackers can exploit parameters like MAC addresses, AIDs, SN, and PN to correlate device activity and track user movement over time. To address this privacy concern, EDP mechanisms are developed, which dynamically update these identifiers at defined epochs to reduce the risk of long-term tracking.

Frames and procedures used in EDP are being defined in IEEE 802.11bi. One of the parameters that can be anonymized under EDP is the AID. AID is assigned by an AP to a non-AP station (STA), and used by the AP to identify the STA within a basic service set (BSS). Changing the AID at each EDP epoch improves privacy by making it harder for attackers to track a device over time based on a fixed identifier. To facilitate efficient AID management, the AP may assign multiple AIDs to a STA within a single frame, with the assigned AIDs covering multiple upcoming epochs. This approach allows the STA to use stored AIDs without requiring frequent reassignments, and therefore reduces signaling overhead and improves the overall network efficiency. However, due to storage limitations or operational constraints, a STA may not be able to store all assigned AIDs at once. Without a reporting mechanism, the AP remains unaware of the STA's constraints, which potentially leads to inefficient AID allocation and mismanagement of network resources.

The present disclosure provides methods, systems, and apparatuses for STAs to evaluate assigned AIDs and communicate feedback to the AP for adaptive AID management. In one embodiment, the AP assigns a list of AIDs to the STA for use in subsequent epochs. The STA evaluates the list and responds with a status code indicating whether it can store all, part, or none of the assigned AIDs. Examples of status codes may include “STATUS_SUCCESS” (if the STA successfully stores all assigned AIDs), “STATUS_TOO_MANY_EPOCHS” (if the assigned list exceeds the STA's storage capacity, in which case the STA may report its maximum storage size available for AID storage), “STATUS_PARTIALLY_STORED” (if the STA stores only part of the list, in which case the STA may inform the AP of the number of stored AIDs), and “STATUS_RETRY_LATER” (e.g., if the start epoch (SE) is too far in the future, and the STAs requests the AP to resend the list at a later time).

In another embodiment, the STA proactively requests an AID list from the AP, providing details such as storage capacity and preferred update timing. The AP responds with an AID list, and the STA evaluates it and confirms storage status using the status codes discussed above.

In another embodiment, the AP advertises available EDP groups with specific minimum storage requirements and/or update frequency (e.g., epoch interval). A STA cannot join an EDP group if it does not meet the required minimum storage size. The STA sends a request to join a specific EDP group and reports its capabilities (e.g., maximum storage size, advance notice preferences). The AP then either approves or rejects the request. Additionally, in some embodiments, the AP may assign the STA to an alternative EDP group with a larger epoch interval that better matches the STA's storage capacity.

In another embodiment, such as when the STA repeatedly fails to store assigned AIDs and its stored AIDs are close to being exhausted, the AP sends a reassignment frame to move the STA to an EDP group with a larger epoch interval. This reassignment ensures the STA's stable operation while reducing its burden on AID management. Once the STA successfully stores the newly assigned AIDs and sends back a confirmation response, the AP may move the STA back to the original group. Embodiments of the present disclosure provide an AID feedback mechanism that enables STAs to communicate storage status and constraints to APs. Through effective communications, the STAs and APs can collaborate to manage AID allocations with improved performance.

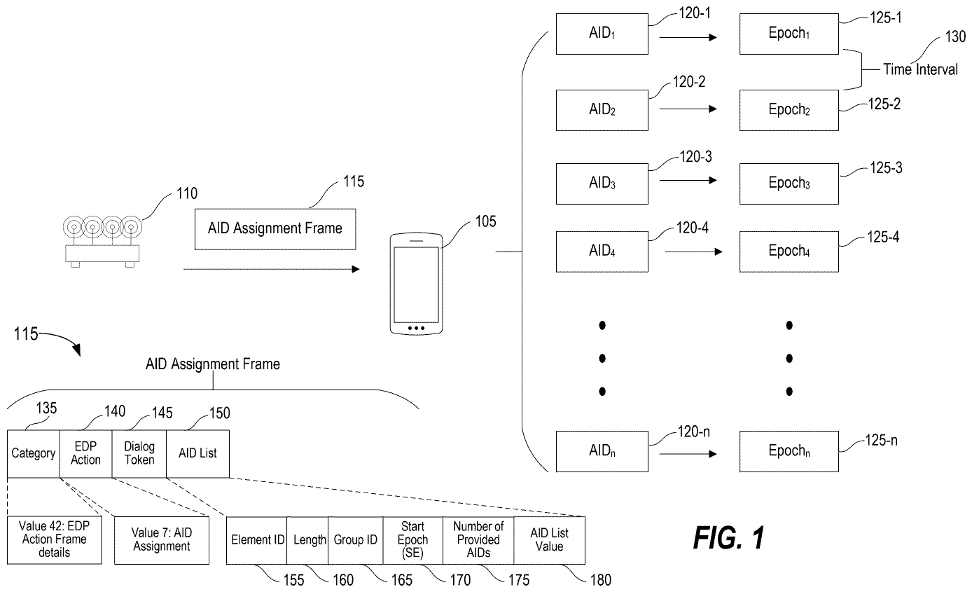

FIG. 1 depicts an example AID assignment frame 115 sent from an AP 110 to a STA 105, according to some embodiments of the present disclosure.

As depicted, an AP 110 sends an AID assignment frame 100 to a STA 105. The STA 105 may be a non-AP multi-link device (MLD), a single-link device, or another type of wireless station. The AP 110 and STA 105 establish association through one or more links, allowing the STA 105 to communicate within the network.

Before receiving an AID assignment, the STA 105 may have already joined an EDP group. As used herein, an EDP group includes a set of STAs that operate under a common AID management. Within the group, each STA updates the AIDs periodically at predefined EDP epochs to prevent long-term tracking. The AP 110 may advertise available EDP groups, each with specific epoch intervals 130 and/or minimum storage requirements. A group with a larger epoch interval 130 (e.g., 1 day) may have a lower storage size requirement, as longer intervals require few AID updates within the same period of time, reducing the total number of AIDs that need to be stored by the STA 105. The STA 105 evaluates these parameters and sends a request to join a suitable EDP group. Once the STA is accepted into an EDP group, AP 110 assigns AIDs to the STA 105 for use in upcoming epochs.

The AID assignment frame 115 includes a list of AIDs assigned by AP 110 to STA 105 (e.g., a total of N AIDs), each AID 120 corresponding to a specific epoch 125 and being used in a sequential manner. For example, AID₁ 120-1 is applied to Epoch₁ 125-1. AID₂ 120-2 is applied to Epoch₂ 125-2, and so on, with AIDₙ 120-n applied to Epochₙ 125-n. The pre-assignment of AIDs reduces signaling overhead and improves network efficiency. In some embodiments, the AID assignment frame 115 may also be referred to as a unicast protected action frame. In some embodiments, the list of AIDs may be represented in a full list format (where all AIDs are explicitly included) or in a delta encoding format (where only an initial AID is provided along with offset values to compute subsequent AIDs).

As depicted, the AID assignment frame is structured to include a Category field 135, an EDP Action field 140, a Dialog Token field 145, and an AID List element 150. The Category field 135 indicates the category of the action frame. For an EDP action frame, a predefined value of 42 is included within the field to differentiate it from other types of action frames (e.g., protected high throughput (HT) action frame, protected very high throughput (VHT) action frame). The EDP Action field 140 specifies the type of EDP action being performed. For AID assignment, this field is set to 7, distinguishing it from other EDP-related actions (e.g., EDP group parameter frames, EDP epoch request frames, EDP epoch response frames). The Dialog Token field 145 is set to a nonzero value to track request/response transactions between the AP and STA. The AID List element 150 contains a sequence of AID values assigned to the STA for use in contiguous EDP epochs.

Within the AID List element 150, the following subfields are included: an Element ID field 155, a Length field 160, a Group ID field 165, a Start Epoch (SE) field 170, a Number of Provided AIDs field 175, and an AID List Value field 180. The Element ID field 155 includes values that identify the AID List Element 150 within the AID assignment frame 115. The Length field 160 specifies the total length of the AID List element 150. The Group ID field 165 indicates the EDP group to which the STA belongs. This allows the AID assignments follow the group's epoch update rules.

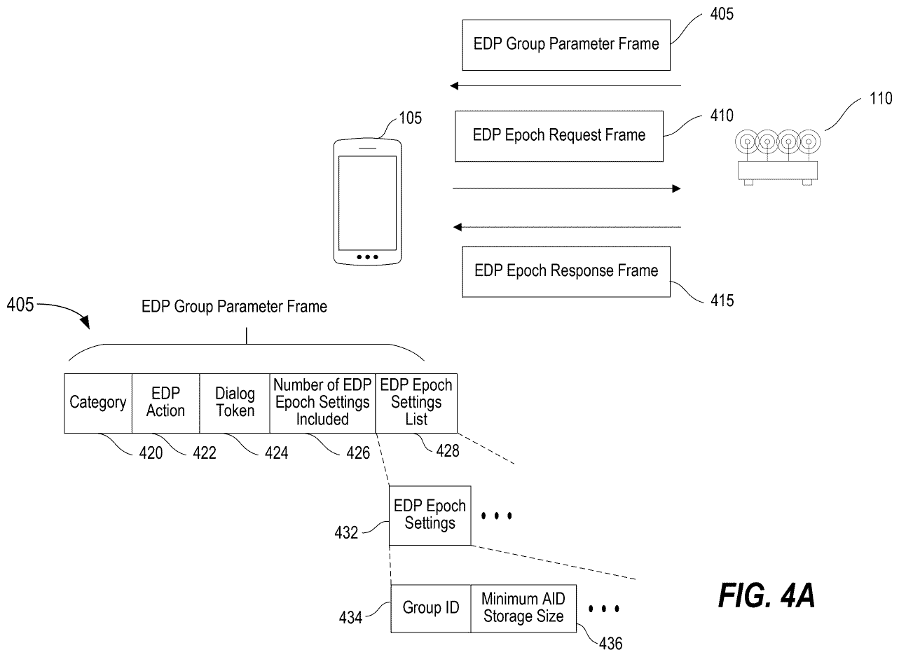

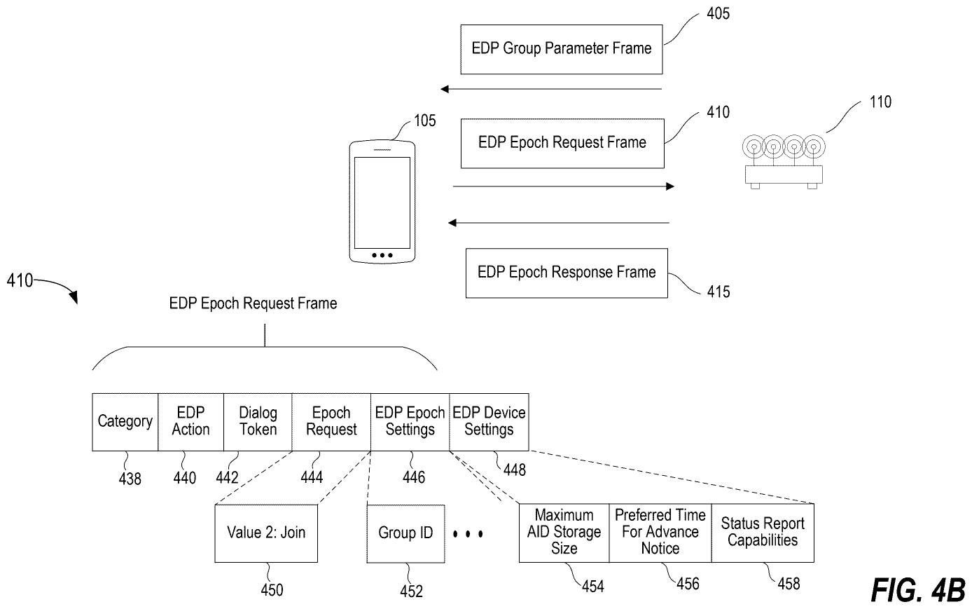

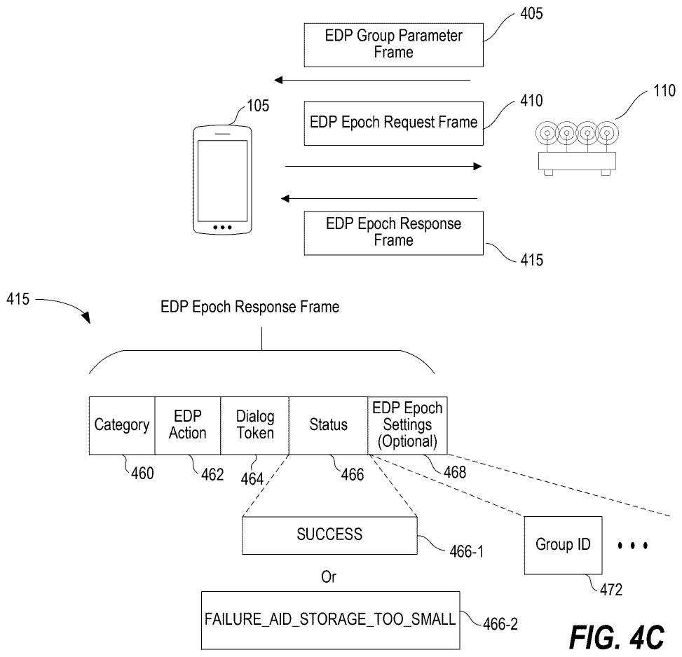

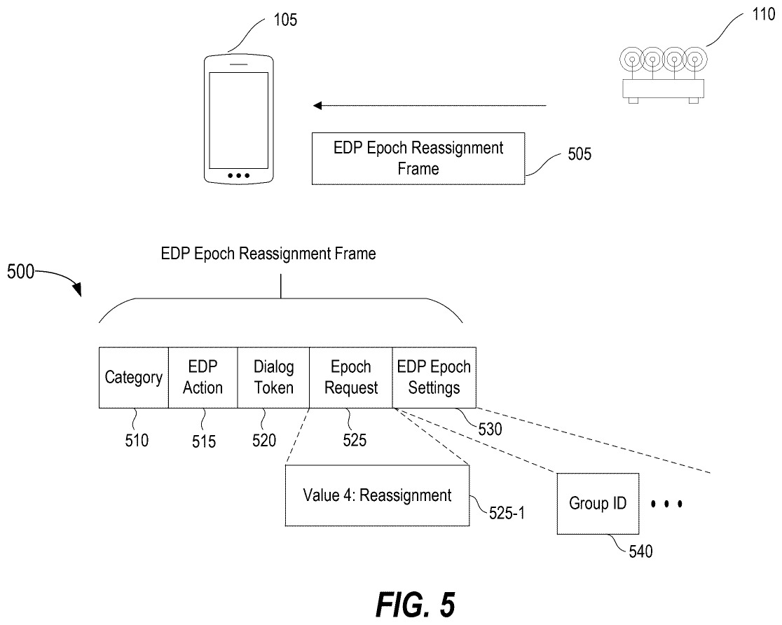

As used herein, an EDP group refers to a set of STAs 105 that share a common AID management policy. Within the EDP group, each STA updates its AIDs periodically at predefined EDP epochs. A group with a larger epoch interval (e.g., 1 day) may require fewer AID updates over time, reducing the total number of AIDs that need to be stored and allowing for a low storage requirement. STAs 105 may select an appropriate EDP group based on their storage capacity/size and operational constraints before receiving an AID assignment 115. More details about STAs 105 joining an EDP group are discussed below with reference to FIGS. 4A-4C and FIG. 5.

The SE field 170 defines the first epoch in which the assigned AIDs take effect. The Number of Provided AIDs specifies the total number of AIDs assigned in frame 115. The AID List Value field 180 contains the actual AID value assigned to the STA for use in different epochs. Each AID entry is stored in a fixed-length format (e.g., 11-bit values for standard AID assignment). The AIDs values are ordered sequentially, where each value corresponds to a specific contiguous epoch following the SE field. For example, when the AP assigns a total of N AID values, AID₁ 120-1 is used in Epoch₁ 125-1 (which is the Start Epoch), AID₂ 120-1 is used in Epoch₂ 125-2, and so on, with AIDₙ 120-n used in Epochₙ 125-n. The structure ensures that each AID value is applied in the correct chronological order without requiring STA to perform additional processing for mapping AIDs to specific epochs.

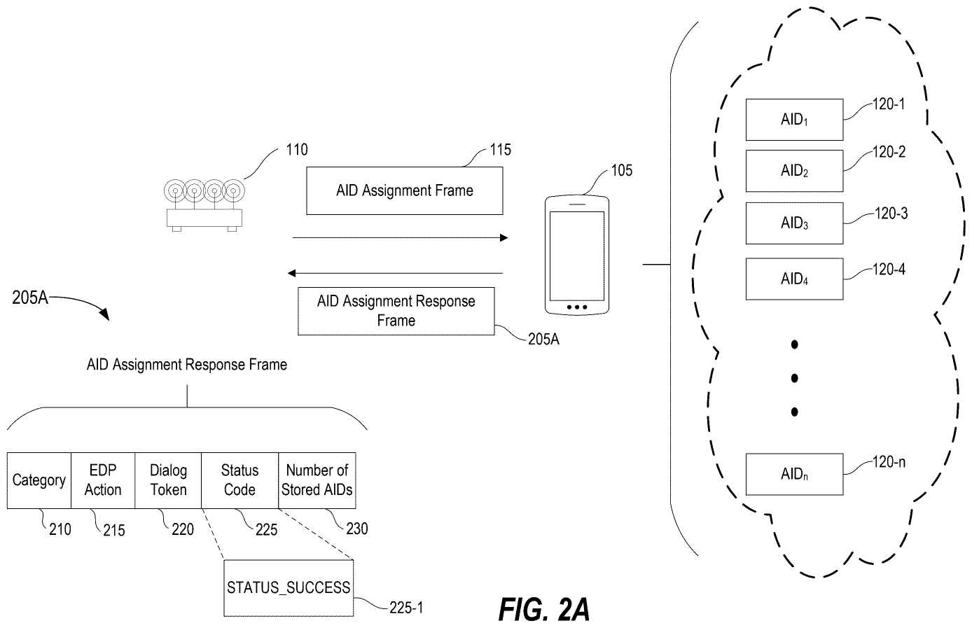

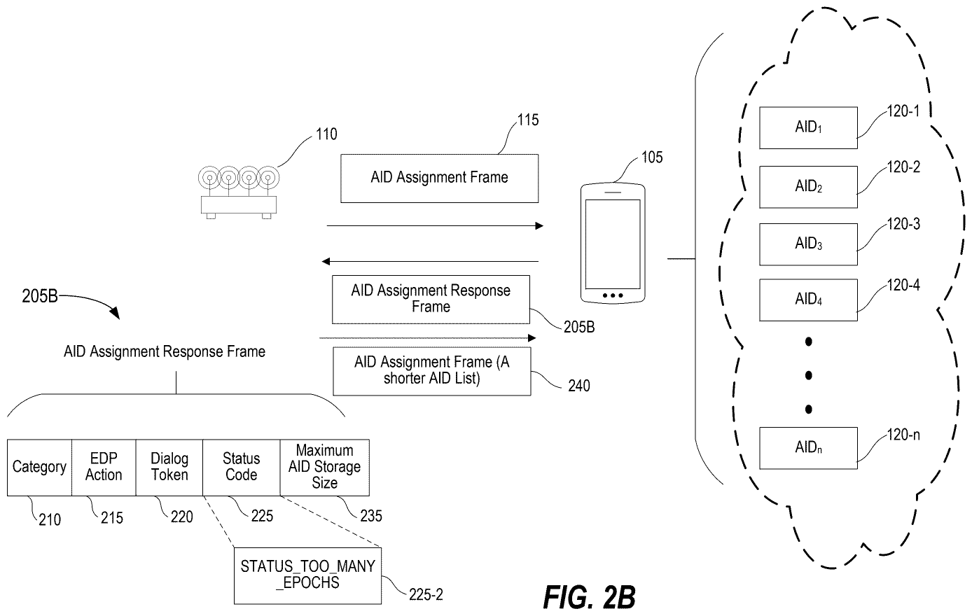

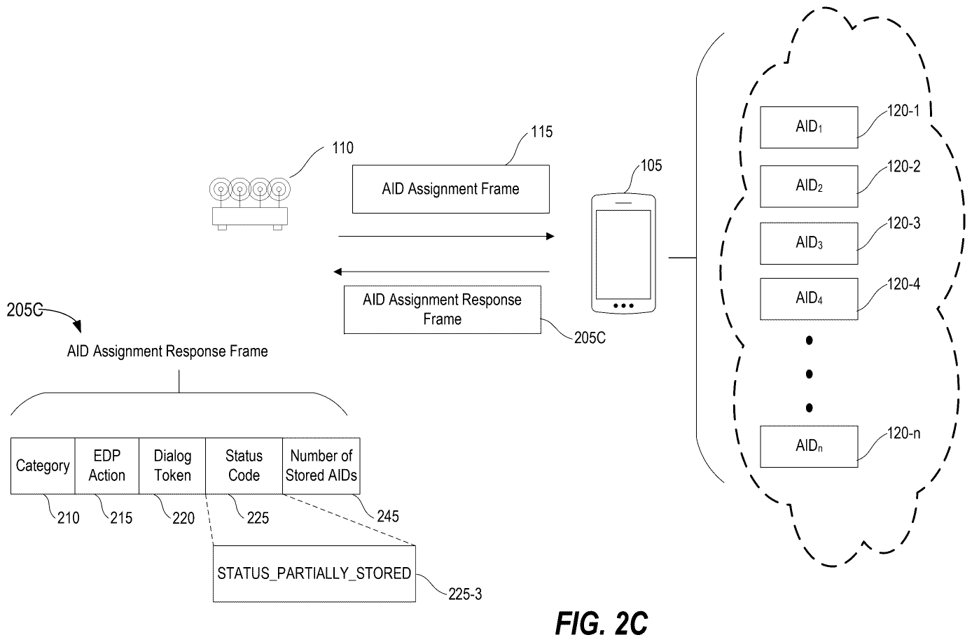

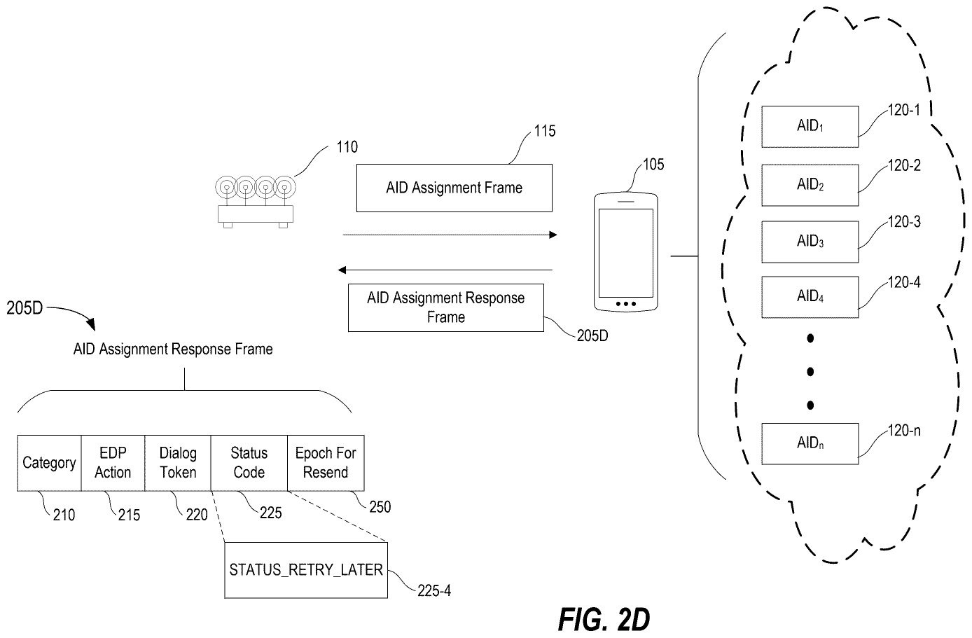

FIGS. 2A-2D depict example AID assignment response frames 205A-D sent from a STA 105 to an AP 110, each indicating a different status code, according to some embodiments of the present disclosure. The AID assignment response frames 205A-D are sent in response to an AID assignment frame 115 received from AP 110.

FIG. 2A depicts an example AID assignment response frame 205A indicating a successful storage of the assigned AID list. Upon receiving the AID assignment frame 115, STA 105 evaluates its own storage capacity and relevant operational requirements to determine if it can fully store the assigned AID list 120. As depicted in FIG. 2A, the evaluation confirms that all assigned AIDs can be stored, and STA 105 transmits an AID assignment response frame 205A to AP 110, indicating successful storage.

As depicted, multiple fields are included within the AID assignment response frame 205A, communicating the status of AID assignment to AP 110. The fields include a Category field 210, an EDP Action field 215, a Dialog Token field 220, a Status Code field 225, and a Number of Stored AIDs field 230 (optional). The Category field 210 identifies the frame 205A as an EDP action frame (e.g., a predefined value of 42 to distinguish the response frame 205A from other action frames). The EDP Action field 215 specifies the type of EDP action being performed. For AID assignment response, the field 215 is set to 7, indicating the frame 205A is AID assignment-related. The Dialog Token field 220 is set to a nonzero value to identify the request/response transaction. The Status Code field 225 indicates the result of the AID assignment request. Here, all assigned AIDs 120 are successfully stored by STA 105. Therefore, the Status Code field 225 includes a status code named “STATUS_SUCCESS”, which represents the successful acceptance and storage of the assigned AID list. The Number of Stored AIDs field 230 indicates the total number of AIDs successfully stored by the STA 105. In this configuration, the STA 105 stores N AID values 120, which corresponds to the number assigned in the AID assignment frame 115 from the AP 110. By sending the AID assignment response frame 205A, the STA 105 confirms the successful storage of assigned AIDs, allowing the AP 110 to proceed with future AID updates or assignments without requiring modifications to the current list.

FIG. 2B depicts an example AID assignment response frame 205B that indicates the assigned AID list exceeds its storage capacity. After receiving the first AID assignment frame 115, the STA 105 evaluates its storage capacity and determines that the number of assigned AIDs exceeds its storage limit. In response, the STA 105 includes a status code 225-2 named “STATUS_TOO_MANY_EPOCHS” in the AID assignment response frame 205B and reports its maximum AID storage size. Based on the feedback, the AP 110 sends an updated AID assignment frame 240 with a shortened AID list that matches the STA's storage limit. For example, if the STA 105 indicates that it can only store (N−5) AIDs, the updated AID assignment frame 240 may include (N−5) AIDs.

The AID assignment response frame 205B in FIG. 2B includes similar fields to those described in FIG. 2A, such as the Category field 210 (value 42 for EDP action frame), the EDP Action field 215 (value 7 for AID assignment-related actions), and the Dialog Token field (a nonzero value for tracking request/response transactions). However, within the Status Code field 225, the response frame 205B includes a different status code, “STATUS_TOO_MANY_EPOCHS” 225-2, to indicate that the STA 105 cannot fully store all assigned AIDs due to its storage limit. The status code 225-2 informs the AP 110 that an adjustment is needed to provide a management AID list. Additionally, the response frame 205B includes a new field, the Maximum AID Storage Size field 235, which reports the STA's maximum capacity for storing AIDs. This value allows the AP to determine the highest number of AIDs that the STA can accommodate without exceeding its storage limitations.

Upon receiving the AID assignment response frame 205B, the AP 110 evaluates the reported maximum AID storage size and generates a new AID assignment frame 240. The new assignment frame 240 includes a shortened AID list that matches or otherwise satisfies the STA's storage limit. This updated AID assignment frame retains similar fields as the original frame 115 but modifies the AID List element (e.g., 150 of FIG. 1), with the number of AIDs provided matching (or being less than) the STA's reported storage limit to prevent storage overflow. For example, if the original AID list contained N AIDs but the STA 105 reported that it can only store (N−5) AIDs, the updated frame 240 will include, at most, (N−5) AIDs. The SE field (e.g., 170 of FIG. 1) within the updated AID assignment frame 240 remains unchanged so that the assigned AIDs are applied sequentially from the original designated epoch. Such an adaptive AID assignment mechanism allows the AP 110 to optimize resource allocation and prevent assignment failures.

FIG. 2C depicts an example AID assignment response frame 205C that indicates the assigned AIDs are partially stored by the STA 105. Upon receiving the AID assignment frame 115, the STA 105 evaluates its storage capacity and determines that it can, at most, store part of the assigned AIDs. In response, the STA 105 sends an AID assignment response frame 205C to notify the AP 110 that a subset of the AID list has been stored successfully. In the response frame 205C, the STA 105 includes a new status code 225-3 named “STATUS_PARTIALLY_STORED”, which informs the AP 110 that not all assigned AIDs have been stored. Additionally, STA 105 reports the number of stored AIDs, allowing the AP 110 to adjust its AID assignment strategy accordingly.

The AID assignment response frame 205C retains the similar fields as those described in FIG. 2A, including the Category field 210, the EDP Action field 215, and the Dialog Token field 220. However, the Status Code field 225 within the frame 205C includes the status code “STATUS_PARTIALLY_STORED” 225-3. This status code notifies the AP 110 that only part of the assigned AID list 120 has been stored. The frame 205C further includes a new field, the Number of Stored AID field 245. This field 245 indicates the actual number of AIDs 120 successfully stored by the STA 105. Based on this value, the AP 110 may adjust its assignment process for future AID allocations (e.g., by providing fewer AIDs in future assignments to the STA).

FIG. 2D depicts an example AID assignment response frame 205D in which the STA 105 requests the AP 110 to resend the AID list at a later time. Upon receiving the AID assignment frame 115, the STA 105 evaluates its storage capacity and operational state. If the assigned AID list is received too early—for example, if the Start Epoch is too far in the future—the STA may determine that it is not yet prepared to store the AIDs. Instead of immediately accepting or rejecting the assignment, the STA 105 responds by requesting the AP 110 to resend the AID list 120 at a later epoch.

As depicted, the AID assignment response frame 205D includes the similar fields to those as described in FIG. 2A, such as the Category field 210 (value 42 for EDP action frame), the EDP Action field 215 (value 7 for AID assignment-related actions), and the Dialog Token Field (a nonzero value for tracking request/response transactions). To communicate the later-resend request, the STA 105 includes the status code “STATUS_RETRY_LATER” 225-4 within the Status Code field 225. The status node notifies the AP 110 that the assigned AIDs should be resent at a later time. Additionally, the assignment response frame 205D further includes an additional field, the Epoch for Resend field 250, which indicates the epoch at which the STA 105 requests to retry sending the AID list.

Upon receiving the AID assignment response frame 205D, AP 110 adjusts its scheduling strategy and defers the AID assignment until the requested epoch. This mechanism enables deferred AID assignment and helps to maintain efficient AID management.

In some embodiments, the AID assignment response frame 205D may not include the Epoch for Resend field 250. When the field is absent, the AP 110 does not have an explicit indication of when the STA 105 prefers to receive the AID list. In such configurations, the AP 110 may decide when to resend the AID assignment frame 115 based on its own scheduling policies. For example, the AP may periodically retry the AID assignment at predefined intervals until a successful response is received. In some embodiments, the AP 110 may resend the AID list when the start epoch (SE) approaches. In some embodiments, historical or contextual information (e.g., typical STA behavior) may be used to determine an optimal (or at least improved) resend time. Although the retry mechanism may lead to some unnecessary retransmissions, it still ensures that the STA 105 eventually receives the AID list at a practical time for proper storage and use. Additionally, redundant transmissions are typically manageable due to the relatively low frequency of AID updates in EDP.

In some embodiments, a threshold or limit may be used to determine whether the SE is too early, helping the STA 105 to determine whether to accept or defer the AID assignment. For example, a threshold value (e.g., T epochs) may be defined as a maximum allowable gap between the current epoch and the SE. If the gap exceeds T epochs, the STA 105 may respond with “STATUS_RETRY_LATER” or other similar indication.

For example, suppose the current epoch is 50, and the AP 110 assigns an AID list with a SE of 100. Suppose further that the STA has a predefined threshold 30 (e.g., T=30). Since the gap between and current epoch is larger than the 30-epoch threshold (e.g., 50>30), the STA 105 determines that the assignment is too early and responds with “STATUS_RETRY_LATER” or other similar indication. Conversely, if the assigned SE is 75—gaps of 25 epochs falling within the threshold—the STA 105 accepts and stores the AID list. The use of a threshold prevents excessive delays while maintaining that the STA 105 only stores AID lists at a practical time relative to its operational needs.

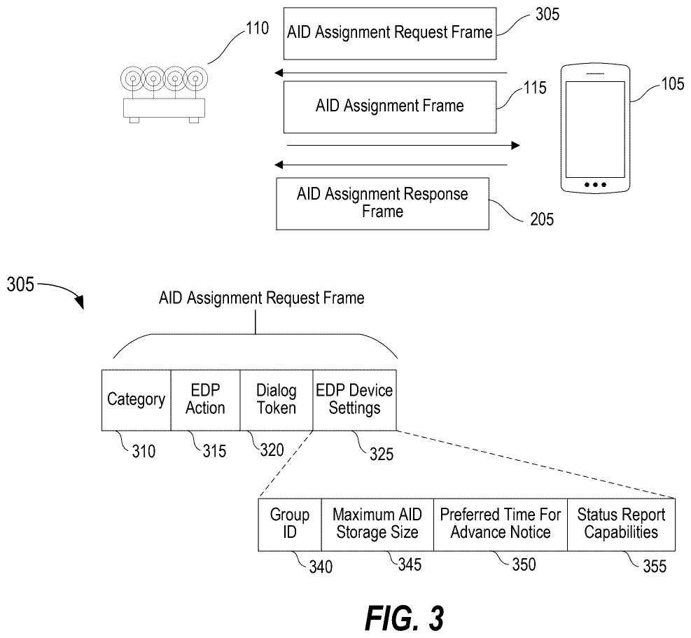

FIG. 3 depicts an example AID assignment request frame 305 sent from a STA to an AP, reporting the STA's storage capacity and preferred advance notice for AID updates, according to some embodiments of the present disclosure.

As depicted, STA 105 proactively sends an AID assignment request frame 305 to AP 110, requesting AID assignment. In response, the AP 110 transmits an AID assignment frame 115 (as previously discussed in FIG. 1) to the STA 105. The STA then evaluates the received AID list and replies with an AID assignment response frame 205 (as discussed in FIGS. 2A-2D).

The AID assignment frame 115 includes similar fields to those discussed in FIG. 1, providing the STA 105 with a structured AID list for upcoming epochs. The AID assignment response frame 205 includes similar fields as those discussed in FIGS. 2A-2D, with variations depending on whether the AIDs are fully stored, partially stored, or received too early.

As depicted, the AID assignment request frame 305 includes the following fields: a Category field 310, an EDP Action field 315, a Dialog Token field 320, and an EDP Device Settings field 325. The Category field 310 identifies the frame as an EDP action frame (e.g., value 42). The EDP Action field 315 indicates the type of EDP action being requested (e.g., value 7 for AID assignment-related actions). The Dialog Token field 320 is set to a nonzero value to identify the request and ensure proper correlation with the AP's response. The EDP Device Settings field 325 allows the STA 105 to communicate its capabilities and preferences regarding AID assignment. As depicted, within the EDP Device Settings field 325, the following subfields are included: a Group ID field 340, a Maximum AID Storage Size field 345, a Preferred Time for Advance Notice field 350, and a Status Report Capabilities field 355. The Group ID field 340 indicates the EDP group that the STA 105 belongs to. This information ensures alignment with the group's AID management policy. The Maximum AID Storage Size field 345 reports the maximum number of AIDs that the STA 105 can store. With this value, the AP may determine the proper number of AIDs for allocation and therefore avoid unnecessary retransmissions. The Preferred Time for Advance Notice field 350 specifies how far in advance the STA 105 prefers to receive a new AID list before exhausting the currently stored list (e.g., T epochs before currently stored AIDs). The Status Report Capabilities field 355 indicates whether STA 105 supports status reporting in its response frame. If enabled, the STA 105 may use status code such as “STATUS_SUCCESS” to indicate success, “STATUS_TOO_MANY_EPOCHS” to indicate that there were too many epochs to be stored, “STATUS_PARTIALLY_STORED” to indicate that the information was partially stored, and/or “STATUS_RETRY_LATER” to request STA 105 to retry at a later time.

The disclosed proactive AID assignment request 305 allows the STA 105 to communicate its storage capacity and preference upfront. Based on this information, the AP 110 can assign only the number of AIDs the STA 105 can handle and transmit them when the STA 105 is ready. This approach effectively reduces unnecessary transmissions and signaling overhead—instead of APs periodically sending AID lists to all associated STAs, even when updates are not needed, STAs request new AIDs only when their current assignments are nearing exhaustion.

The fields within the EDP Device Settings field 325, such as the Maximum AID Storage Size field 345, the Preferred Time for Advance Notice field 355, and the Status Report Capabilities field 360, are provided for conceptual clarity. In some embodiments, additional fields may be included to indicate further device capabilities (e.g., preference of receiving a compressed AID list to reduce frame size, the STA's expected operational duration, the STA's support for privacy modes).

FIGS. 4A-4C depict the join phase in which a STA 105 selects and joins an EDP group. Different EDP groups may have different epoch intervals, which determine the frequency of AID updates. The join process allows each STA 105 to join an appropriate EDP group based on its storage capacity and update preferences. The join process typically occurs before AID assignment (as discussed in FIGS. 1, 2A-2D, and 3).

As depicted, the AP first broadcasts available EDP groups to associated STAs 105 via an EDP group parameter frame 405. The STA 105 evaluates the advertised groups and compares epoch intervals, storage requirements, and other relevant parameters to determine which group aligns better with its capabilities and operational needs. The STA 105 then transmits an EDP epoch request frame 410 to the AP 110, requesting to join a specific EDP group. The request may include information such as the STA's storage capacity, preferred update timing, and status reporting capabilities. The AP 110 processes the request 410 and sends an EDP epoch response frame 415 back to the STA 105. The response may indicate approval, rejection, or reassignment to a different EDP group based on the STA's capabilities and group constraints.

FIG. 4A depicts an example EDP group parameter frame 405 sent from an AP to a STA, advertising different EDP groups and their associated parameters. As depicted, the EDP group parameter frame 415 includes the following fields: the Category field 420, the EDP Action field 422, the Dialog Token field 424, the Number of EDP Epoch Settings Included field 426, and the EDP Epoch Settings List field 428.

The Category field 420 identifies the frame 405 as an EDP action frame (e.g., value 42). The EDP Action field 422 specifies the type of EDP action being performed (e.g., value 2 for EDP group advertisement). The Dialog Token field 424 is set to a nonzero value to track request/response transactions between the AP 110 and the STA 105. The EDP Epoch Settings List field 428 includes one or more EDP Epoch Settings fields 432, each field defining the parameters of a specific EDP group that the AP 110 intends to convey to the non-AP STA 105. The Number of EDP Epoch Settings Included field 426 indicates the number of EDP Epoch Settings field 432 contained in the EDP Epoch Settings List field 428. This information helps the STA 105 to determine how many different EDP groups are being advertised.

As depicted, each EDP Epoch Settings field 432 represents a specific EDP group and includes parameters that define the group's characteristics. The subfields included within each EDP Epoch Settings field 432 include a Group ID field 434 and a minimum AID Storage Size field 436. The Group ID field 434 identifies the EDP group to differentiate it from other advertised groups. The Minimum AID Storage Size field 436 specifies the minimum number of AIDs that a STA must be capable of storing to be eligible to join this group. This provides that only STAs with sufficient storage capacity can join the EDP group, preventing assignment failure due to insufficient memory.

The subfields within the EDP Epoch Settings field 432 are provided for conceptual clarity. In some embodiments, other fields may be included depending on implementation requirements, such as epoch intervals, privacy settings, or additional requirements that help the STA to decide an appropriate EDP group before sending a join request.

FIG. 4B depicts an example EDP epoch request frame 410 sent from a STA to an AP. The EDP epoch request frame 410 is used by the STA 105 to join a specific EDP group. After receiving the EDP group parameter frame 405 from the AP 110, the STA 105 evaluates the advertised groups and selects one that aligns with its storage capacity and operational preferences. The STA then transmits an EDP epoch request frame 410 to AP 110, signaling its intent to join the selected group.

As depicted, the EDP epoch request frame 410 includes the following fields: a Category field 438, an EDP Action field 440, a Dialog Token field 442, an Epoch Request field 444, an EDP Epoch Settings field 446, and an EDP Device Settings field 448. The Category field 438 identifies the frame 410 as an EDP action frame (e.g., value 42). The EDP Action field 440 indicates the type of the frame being sent. For an EDP epoch request, this field is set to 3. The Dialog Token field 442 is used to track request/response transactions between the AP and STA. The Epoch Request field 444 indicates the specific action related to the EDP epoch. For example, a value 2 may be used to specify a join action, distinguishing it from other actions such as creating a new group (e.g., value 1) or leaving an existing group (e.g., value 3). The EDP Epoch Settings field 446 includes parameters related to the EDP group the STA 105 intends to join. As depicted, a Group ID subfield 452 is included within the EDP Epoch Settings field 446. The Group ID subfield 452 includes the ID of the EDP group that the STA 105 is requesting to join. The EDP Device Settings field 448 provides additional information about the STA's 105 capabilities and preferences for AID assignment. As depicted, the EDP Device Settings field 448 includes a Maximum AID Storage Size field 454 (indicates the maximum number of AIDs the STA 105 can store), a Preferred Time for Advance Notice field 456 (indicates how far in advance the STA 105 intends to receive AID updates before its current assignments expire), and a Status Report Capabilities field 458 (indicates whether the STA 105 supports reporting storage status and assignment results in its response frame).

The three subfields within the EDP Device Settings field 448 are provided for conceptual clarity. In some embodiments, the EDP Device Settings field 448 may include additional subfields to indicate further device capabilities and preferences. Based on the information provided within the EDP epoch request frame 410, the AP 110 evaluates whether the STA 105 meets the requirements of the requested EDP group. For example, if the group that the STA's 105 requests to join has a minimum AID storage requirement (e.g., 20 AIDs) but the STA's 105 request frame indicates its maximum storage size is only 15 AIDs, the AP may reject the request since the STA 105 does not meet the group's storage requirements. In this configuration, the AP 110 may either reject the request entirely, requiring the STA to select another group and resend a request, or assign the STA 105 to a different EDP group that has a larger epoch interval (where fewer AIDs are needed), making it compatible with the STA's lower storage capacity. If the STA's 105 request frame specifies a maximum AID storage size that meets or exceeds the group's minimum requirement, the AP 110 may approve the request and assign the STA to the selected EDP group. The AP 110 may convey its decision by sending an EDP epoch response frame to the STA 105, indicating whether the STA 105 has successfully joined the requested group. In embodiments where the STA 105 provides a preferred time for advance notice (e.g., 7 epochs), the AP 110 may consider this information when determining whether to approve the request.

FIG. 4C depicts an example EDP epoch response frame 415 sent from an AP to a STA, indicating the status of the STA's request to join an EDP group.

As depicted, the EDP epoch response frame 415 includes a Category field 460, an EDP Action field 462, a Dialog Token field 464, a Status field 466, and an EDP Epoch Settings field 468. The Category field 460 indicates the frame 415 as an EDP action frame (e.g., value 42), distinguishing it from other action frames (e.g., protected HT action frames, protected VHT action frames). The EDP Action field 462 specifies the type of the frame being sent. For an EDP epoch response, this EDP Action field 462 includes a value 4 to indicate a response to the STA's join request. The Dialog Token field 464 is set to a nonzero value to track request/response transactions between the AP and STA. The Status field 466 indicates the result of the STA's join request. If the request is approved, a status code named “SUCCESS” 466-1 is included. If the request is rejected, a status code named “FAILURE_AID_STORAGE_TOO_SMALL” 466-2 is included, indicating the join fails because the STA's maximum storage size is too small for the requested group.

The EDP Epoch Settings field 468 may be included when the join request is rejected and the AP recommends an alternative EDP group that the STA may join. The alternative EDP group may have a larger epoch interval, which may be better suited for the STA's storage capabilities. As depicted, the EDP Epoch Settings field 468 includes a Group ID subfield 472, which contains the ID of the alternative EDP group suggested by the AP 110. The depicted Group ID subfield 472 is provided for conceptual clarity. In some embodiments, other parameters of the alternative group may be provided within the EDP Epoch Settings field 468.

In embodiments where the EDP epoch response frame 415 includes a rejection code along with a recommended EDP group ID, STA 105 may process the response and determine the next action. In one embodiment, the STA 105 may evaluate the recommended group and decide whether to proceed with joining. If the STA 105 accepts the recommendation, the STA 105 may send a new EDP epoch request 410 that specifies the recommended group ID. While this approach may result in an additional request-response exchange, it maintains a clear and structured group selection process.

In another embodiment, the STA 105 may be allowed to accept the recommended group automatically and send a direct response rather than initiating a new request. In this configuration, the STA 105 may send an acknowledgement frame or a modified EDP epoch request frame indicating that it accepts the recommended group without requiring another round of AP evaluation. This approach eliminates an additional request-response cycle and, therefore, reduces overall signaling overhead in the wireless network.

FIG. 5 depicts an example EDP epoch reassignment frame 505 sent from an AP to a STA, assigning the STA to another EDP group, according to some embodiments of the present disclosure.

The EDP epoch reassignment frame 505 is used when the AP 110 needs to reassign a STA 105 to a different EDP group. This may occur when the STA 105 does not respond to AID assignment or repeatedly fails to store the full AID list, exceeding a defined failure threshold. The AP 110 may determine that the STA 105 is not suitable for the current EDP group and reassign it to another group with a larger epoch interval (fewer AID updates). As depicted, the EDP epoch reassignment frame 505 includes the following fields: a Category field 510, an EDP Action field 515, a Dialog Token field 520, an Epoch Request field 525, and an EDP Epoch Settings field 530.

The Category field includes value 42 to identify frame 505 as an EDP action frame. The EDP Action field 515 indicates the type of the frame being sent. In some embodiments, a reserved value (e.g., value 8) may be used to indicate this is an EDP reassignment frame. The Dialog Token field 520 is used to track request/response transactions between the AP and STA. The Epoch Request field 525 specifies the action type related to the EDP epoch. In some embodiments, a reserved value (e.g., value 4) 525-1 may be used to indicate that this frame is a reassignment action, distinguishing it from other actions like create, join, or leave.

The EDP Epoch Settings field 530 includes information about the new EDP group to which the STA 105 is reassigned. As depicted, the EDP Epoch Settings field 530 includes a Group ID subfield 540, which indicates the identifier of the new EDP group. In some embodiments, additional group parameters may be included within the EDP Epoch Settings field 530, such as group interval or privacy or security settings.

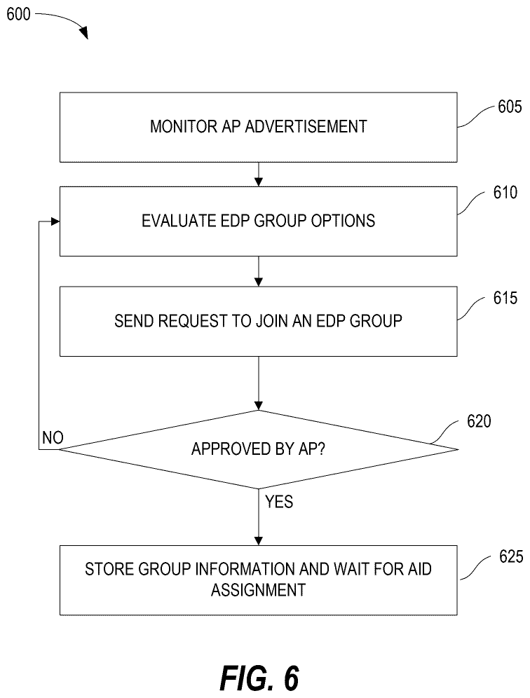

FIG. 6 depicts an example method 600 for a STA joining an EDP group, according to some embodiments of the present disclosure. In some embodiments, the method 600 may be performed by one or more non-AP devices, such as STA 105 as depicted in FIGS. 1, 2A-2D, 3, 4A-4C, and 5.

At block 605, a STA (e.g., 105 of FIG. 5) listens for EDP group parameter frames (e.g., 405 of FIG. 4A) transmitted by its associated AP (e.g., 110 of FIG. 5). The EDP group parameter frames advertise the available EDP groups within the current network, and provide detailed information for each EDP group, such as Group ID, epoch intervals, minimum AID storage requirements, and privacy and security parameters (if applicable). By monitoring these advertisements, the STA gathers the information to evaluate which EDP group better matches its capabilities and operational needs.

At block 610, the STA processes the received EDP group parameter frames and evaluates which group aligns better with its storage capacity and preferred AID update timing. If multiple groups are available, the STA may select the most suitable group based on epoch interval, minimum AID storage requirement, and other relevant parameters (e.g., privacy policies or security settings).

At block 615, the STA transmits an EDP epoch request frame (e.g., 410 of FIG. 4B) to the AP. Within the request frame, the STA includes the Group ID of the chosen EDP group. In addition, the request frame may further include the STA's maximum storage capacity, the STA's preferred advance notice for AID updates, and whether the STA supports status reporting in response to AID assignments.

At block 620, the STA checks AP's response to determine whether the join request is approved or rejected. If the join request is approved (e.g., the AP's response includes the status code “SUCCESS”), the STA successfully joins the requested group, and the method 600 proceeds to block 625.

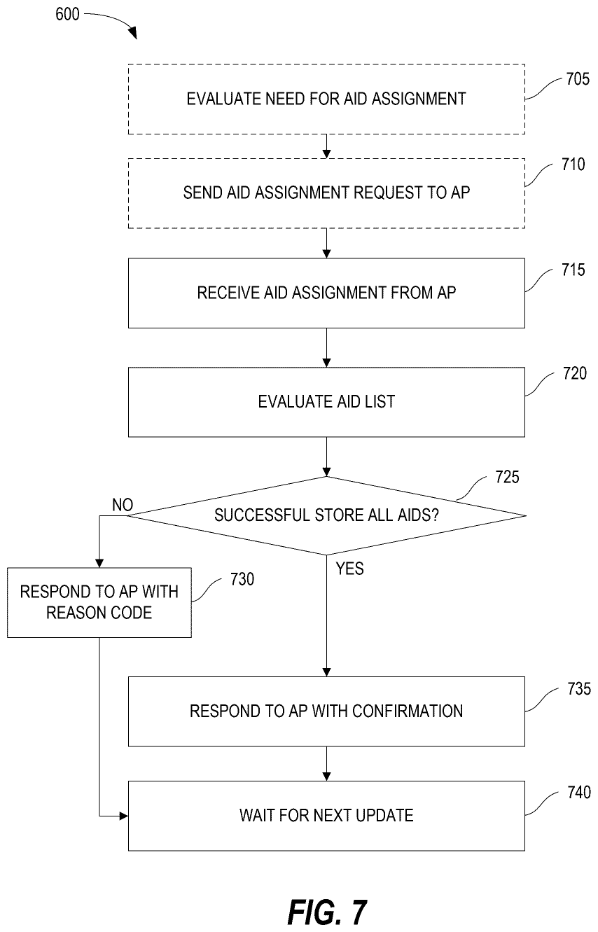

At block 625, the STA stores the assigned EDP group ID and relevant group parameters. The STA then prepares for AID assignment. More details about AID assignment are discussed in FIG. 7.

If the join request is rejected (e.g., AP's response includes the status code “FAILURE_AID_STORAGE_TOO_SMALL”, indicating that the STA's storage capacity is insufficient for the requested group), the method returns to block 610, where the STA reevaluates the available EDP groups and selects another group to request. In embodiments where the AP's response includes a recommended EDP group (e.g., a group with a larger epoch interval, requiring fewer stored AIDs), the STA may review the recommended group and its parameters. If the STA finds the recommended group suitable, the STA may send another request or join the group directly by sending an acknowledgement frame (or a modified EDP epoch request frame) to the AP. The acknowledgement frame (or the modified EDP epoch request frame) indicates that the STA accepts the recommended group without another round of AP evaluation.

FIG. 7 depicts an example method 700 for a STA receiving and storing an AID list, according to some embodiments of the present disclosure. In some embodiments, the method 700 may be performed by one or more non-AP devices, such as STA 105 as depicted in FIGS. 1, 2A-2D, 3, 4A-4C, and 5.

At block 705, a STA (e.g., 105 of FIGS. 1, 2A-2D, and 3) evaluates whether a new AID assignment is needed. Various factors may be considered, such as whether the STA's current AID list is about to expire and whether the STA expects an update based on its preferred advance notice time.

At block 710, the STA proactively requests an AID assignment by sending an AID assignment request frame (e.g., 305 of FIG. 3) to the associated AP (e.g., 110 of FIGS. 1, 2A-2D, and 3). The request may include information about the STA's storage capacity/size, preferred update timing, and status reporting capability. In some embodiments, the operations at blocks 705 and 710 may be optional. The STA does not proactively request an AID assignment but instead waits for an AID assignment from the AP. In embodiments where the STA does not send a request, the method 700 starts from block 715.

At block 715, the STA receives an AID assignment frame (e.g., 115 of FIG. 1) from the AP. The assignment frame includes a list of AIDs (e.g., 120 of FIG. 1) assigned for use in subsequent epochs (e.g., 125 of FIG. 1), as well as a SE value (e.g., 170 of FIG. 1) that indicates the first AID should be used. In some embodiments, the assignment frame may further include the total number of AIDs provided by the AP (e.g., 175 of FIG. 1).

At block 720, the STA evaluates the received AID list, including checking whether it can store all assigned AIDs based on its maximum storage size and verifying whether the SE is not too early for storage. At block 725, the STA determines whether a storage of the full assigned AID list has been performed. If yes, the method 700 proceeds to block 735, where the STA sends an AID assignment response frame (e.g., 205A of FIG. 2A) with the status code “STATUS_SUCCESS” or other similar indication. This response frame confirms that the AIDs have been stored entirely. If the STA encounters issues storing the AID list, such as the list exceeding its storage capacity or the assignment arriving too early to store, the method 700 moves to block 730.

At block 730, the STA responds to the AP with a proper reason code, indicating the issue and providing relevant information for the AP to adjust future assignments. If the STA stores part of the AID list, the STA may send an AID assignment response frame with the status code “STATUS_PARTIALLY_STORED” (e.g., 205C of FIG. 2C). Additionally, the STA may include a field (e.g., 245 of FIG. 2C) reporting the number of AIDs successfully stored, allowing the AP to adjust the next AID assignment. If the STA cannot store the full AID list due to storage limits, it may send an AID assignment response frame with the status code “STATUS_TOO_MANY_EPOCHS” (e.g., 205B of FIG. 2B). The STA may also report its maximum storage size to the AP (e.g., 235 of FIG. 2B). Based on the response, the AP may send a new AID assignment frame with a shorter AID list that matches the STA's storage capacity. If the STA determines that the SE is too far in the future, the STA may send an AID assignment response frame with the status code “STATUS_RETRY_LATER” (e.g., 205D of FIG. 2D). In some embodiments, the STA may include a suggested epoch (e.g., 250 of FIG. 2D) for resending the AID list, guiding the AP on which it should provide a new AID assignment.

After successfully storing the AID list for responding with a reason code, the method 700 proceeds to block 740, where the STA waits for the next scheduled AID update. In embodiments where the STA requested a shorter AID list, the STA may wait for the AP to send a new assignment. The method repeats when the next assignment is desired.

In some embodiments, the STA may fail to send a response to the AP (as depicted at blocks 730 and 735) after receiving an AID assignment frame, or it may repeatedly fail to store the full AID list, exceeding a defined failure threshold. These failures indicate that the STA is struggling to manage its assigned AID updates within its current EDP group. In this configuration, the AP may initiate a reassignment by sending an EDP epoch reassignment frame (e.g., 505 of FIG. 5) to the STA, moving the STA to a group with a larger epoch interval. Here, a larger epoch interval reduces the frequency of AID updates, which may help the STA manage its storage limitations more effectively. If, after reassignment, the STA is later able to manage AID assignment successfully (e.g., sending proper response and storing all assigned AIDs), the AP may then move the STA to its original group with a smaller interval. In some embodiments, the STA may send another EDP epoch request frame (e.g., 410 of FIG. 4B), requesting to rejoin the original group. In some embodiments, the AP may monitor the STA's response and dynamically adjust the STA's group based on success rates (e.g., by sending an EDP epoch reassignment frame to the STA). If the STA repeatedly fails to store the full AID list, even after reassignment, the AP may move the STA to another group with an even larger epoch interval. If the STA successfully stores its AID list for multiple consecutive epochs, the AP may determine that the STA can handle more frequent updates. In this configuration, the AP may move the STA to a group with a smaller epoch interval (e.g., the original group). The adaptive reassignment mechanism allows to adjust STA's group based on its actual storage performance. This approach improves network efficiency and reduces unnecessary AID assignment failures.

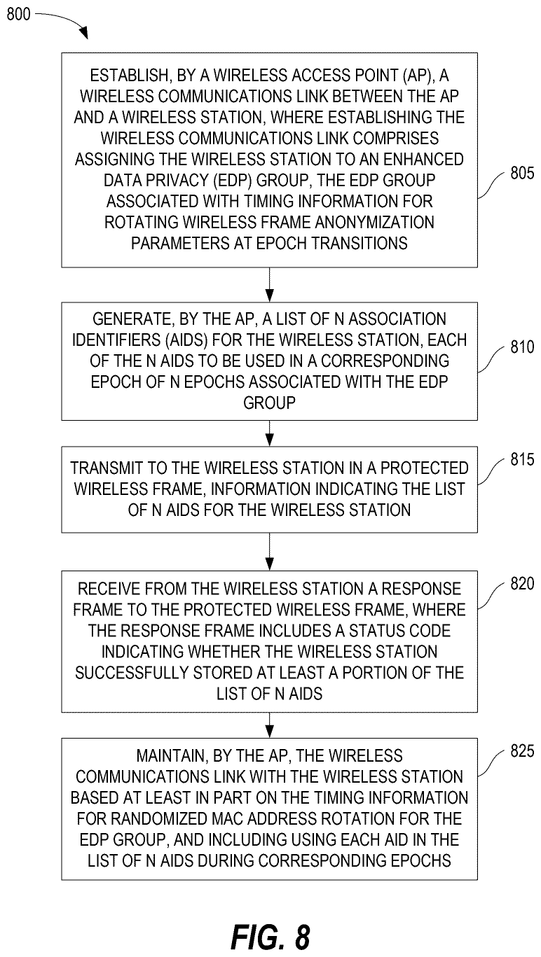

FIG. 8 is a flow diagram depicting an example method 800 of a STA receiving, evaluating, and responding to an AID assignment from an AP, according to some embodiments of the present disclosure.

At block 805, a wireless access point (AP) (e.g., 110 of FIGS. 1, 2A-2D, 3, 4A-4C, and 5) establishes a wireless communications link between the AP and a wireless station (e.g., 105 of FIGS. 1, 2A-2D, 3, 4A-4C, and 5), where establishing the wireless communications link comprises assigning the wireless station to an Enhanced Data Privacy (EDP) group, the EDP group associated with timing information for rotating wireless frame anonymization parameters at epoch transitions.

At block 810, the AP generates a list of N association identifiers (AIDs) for the wireless station, each of the N AIDs to be used in a corresponding epoch of N epochs associated with the EDP group.

At block 815, the AP transmits to the wireless station in a protected wireless frame (e.g., 115 of FIGS. 2A-2D), information indicating the list of N AIDs for the wireless station.

At block 820, the AP receives from the wireless station a response frame (e.g., 205A of FIG. 2A or 205B of FIG. 2B) to the protected wireless frame, where the response frame includes a status code indicating whether the wireless station successfully stored at least a portion of the list of N AIDs.

At block 825, the AP maintains the wireless communications link with the wireless station based at least in part on the timing information for randomized MAC address rotation for the EDP group, and including using each AID in the list of N AIDs during corresponding epochs.

In some embodiments, the AP may further provide a first communication indicating that the AP supports a randomized Media Access Control (MAC) address rotation management protocol.

In some embodiments, the AP may further receive, from the wireless station, an AID storage capability parameter indicating a maximum storage for the list of N AIDs.

In some embodiments, if the status code indicates a failure, the AP may further generate a second list of N association identifiers (AIDs) for the wireless station, each of the N AIDs to be used in a corresponding epoch of N epochs associated with the EDP group, and transmit to the wireless station in a protected wireless frame, information indicating the second list of N AIDs for the wireless station.

In some embodiments, the AP may receive a wireless frame indicating a request by the wireless station for a new list of N AIDs.

In some embodiments, the status code (e.g., 225-1 of FIG. 2A) may indicate acceptance of the list of N AIDs by the wireless station.

In some embodiments, the status code (e.g., 225-3 of FIG. 2C) may indicate storage, by the wireless station, of a portion of the list of N AIDs.

In some embodiments, the status code (e.g., 225-2 of FIG. 2B) may indicate that the list of N AIDs is too large for the wireless station.

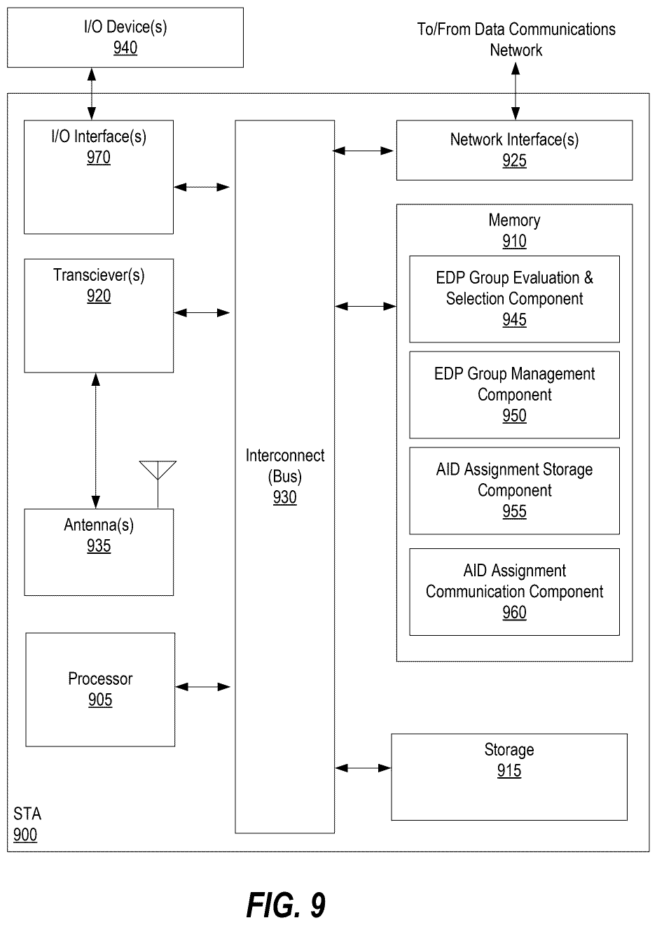

FIG. 9 depicts an example client device 900 configured to perform various aspects of the present disclosure, according to some aspects of the present disclosure. In some embodiments, the example network device 900 may be a non-AP STA, which corresponds to STA 105 as depicted in FIGS. 1, 2A-2D, 3, 4A-4C, and 5.

As illustrated, the example network device 900 includes a processor 905, memory 910, storage 915, one or more transceivers 920, one or more I/O interfaces 980, and one or more network interfaces 925. In some embodiments, I/O devices 940 are connected via the I/O interface(s) 980. Further, via the network interface 925, the network device 900 can be communicatively coupled with one or more other devices and components (e.g., via a network, which may include the Internet, local network(s), and the like). Each of the components is communicatively coupled by one or more buses 930. In some embodiments, one or more antennas 935 may be coupled to the transceivers 920 for transmitting and receiving wireless signals.

The processor 905 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 905 processes information received through the transceiver 920, I/O interfaces 980, and the network interfaces 925. The processor 905 retrieves and executes programming instructions stored in memory 910, as well as stores and retrieves application data residing in storage 915.

The storage 915 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 915 may store a variety of data for the efficient functioning of the system.

The memory 910 may include random access memory (RAM) and read-only memory (ROM). The memory 910 may store processor-executable software code containing instructions that, when executed by the processor 905, enable the network device 900 to perform various functions described herein for wireless communication. In the illustrated example, the memory 910 includes four software components: the EDP group evaluation & selection component 945, the EDP group management component 950, the AID assignment storage component 955, and the AID assignment communication component 960.

In one embodiment, the EDP group evaluation & selection component 945 is configured to evaluate advertised EDP groups and determine the suitable group for the client device 900 based on its storage limitations and operational requirements. More specifically, the EDP group evaluation & selection component 945 processes EDP group parameter frames (e.g., 405 of FIG. 4A) received from the AP, extracts group parameters (e.g., epoch interval and minimum storage requirements), and compares the extracted data against the client device's capabilities. After evaluating the available options, the EDP group evaluation & selection component 945 determines which group better matches the client device's requirements and forwards the selection to the EDP group management component 950 to initiate a joining process.

In one embodiment, the EDP group management component 950 is configured to handle the client device's interaction with the AP during the joining process. Specifically, the EDP group management component 950 may transmit EDP epoch request frames (e.g., 410 of FIG. 4B) to the AP, requesting to join a selected group, and processes the AP's response. If the request is approved, the EDP group management component 950 updates the client device's group assignment and prepares for AID assignment. If the request is rejected, the EDP group management component 950 communicates with the EDP group evaluation & selection component 945 to reevaluate available groups. Additionally, if the AP recommends an alternative group, the EDP group evaluation & selection component 945 and EDP group management component 950 may work together to process the recommendation and determine whether to initiate a new request.

In one embodiment, the AID assignment storage component 955 is configured to process, evaluate, and store AID assignments received from the AP. When an AID assignment frame (e.g., 115 of FIG. 1) is received, the AID assignment storage component 955 checks whether the number of assigned AIDs fit within the client device's maximum storage capacity and verifies whether the SE is appropriate for storage. If the assignment is valid, the AID assignment storage component 955 stores the AID list for future use. If any issues arise, such as storage limitations or premature assignments, the AID assignment storage component 955 determines the appropriate response to be sent to the AP.

In one embodiment, the AID assignment communication component 960 manages communications between the client device 900 and the AP regarding AID storage status. More specifically, the AID assignment communication component 960 generates and transmits AID assignment response frames that report whether the AID list has been successfully stored, partially stored, or could not be stored at all. If the client device 900 stores only part of the list, the AID assignment communication component 960 includes a count of stored AIDs in the response. If the assignment exceeds the client device's storage limit, the AID assignment communication component 960 reports its maximum storage size to AP, requesting the AP to resend a shorter AID list. Additionally, if the assignment is received too early, the AID assignment communication component 960 informs the AP and may suggest an epoch for resending the AID list.

To facilitate understanding, identical reference numerals have been used, where possible, to designate identical elements that are common to the figures. It is contemplated that elements disclosed in one embodiment may be beneficially used in other embodiments without specific recitation.

Although depicted as a discrete component for conceptual clarity, in some embodiments, the operations of the depicted components (and others not illustrated) may be combined or distributed across any number of components. Further, although depicted as software residing in memory 910, in some aspects, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

### EXAMPLE CLAUSES

Implementation examples are described in the following numbered clauses:
Clause 1: A method, comprising: receiving, by a client device from an access point (AP), a first AID assignment frame comprising a list of associated identifiers (AIDs) assigned to the client device for use in one or more subsequent epochs; determining that a number of the assigned AIDs within the list exceeds a storage limit of the client device; in response to the determination, transmitting, to the AP, a first AID assignment response frame comprising a first status code indicating a failure of storing the list by the client device; and receiving, from the AP, a second AID assignment frame comprising a revised list with a reduced number of AIDs assigned to the client device.
Clause 2: The method of Clause 1, wherein the first AID assignment further comprises a start-epoch indicating a first epoch where the assigned AIDs to be applied.
Clause 3: The method of Clause 1, wherein the first AID assignment response frame further comprises the storage limit of the client device, and the reduced number of AIDs falls below or is equal to the storage limit.
Clause 4: The method of Clause 3, wherein the method further comprises transmitting, to the AP, a second AID assignment response frame comprising a second status code indicating a success of storing the revised list by the client device.
Clause 5: The method of Clause 1, wherein the method further comprises: receiving, by the client device from the AP, a third AID assignment frame comprising a second list of associated identifiers (AIDs) assigned to the client device for use in one or more epochs; determining that a number of the assigned AIDs within the second list does not exceed the storage limit of the client device; and in response to the determination, transmitting, to the AP, a second AID assignment response frame comprising a second status code indicating a success of storing the second list by the client device.
Clause 6: The method of Clause 1, wherein the method further comprises: storing, by the client device, the list of AIDs up to a storage limit of the client device; and transmitting, to the AP, a second AID assignment response frame comprising at least one of: a second status code indicating partial storage, or a number of AIDs that have been stored by the client device.
Clause 7: The method of Clause 1, wherein the method further comprises: receiving, by the client device from the AP, a third AID assignment frame at a first time, the third AID assignment frame comprising at least one of: a second list of associated identifiers (AIDs) assigned to the client device for use in one or more epochs, or a start-epoch indicating a first epoch where assigned AIDs within the second list to be applied; determining that the start-epoch within the third AID assignment frame is beyond a predefined time limit; and in response to the determination, transmitting, to the AP, a second AID assignment response frame comprising a second status code requesting the second list to be resent at a second time, wherein the second time is a later time than the first time.
Clause 8: The method of Clause 1, wherein the method further comprises: receiving, by the client device, an enhanced data privacy (EDP) group action frame from the AP, indicating a minimum storage size requirement for each of one or more EDP groups; transmitting, by the client device, a request frame to join a first EDP group, within the one or more EDP groups, the request comprises at least one of: the storage limit of the client device for storing AIDs, or a defined time limit for when the client device can store an AID list update; and receiving, by the client device, an EDP group response frame from the AP.
Clause 9: The method of Clause 8, wherein, in response to determining that the storage limit of the client device meets the minimum storage size requirement of the first EDP group, the EDP group response frame comprises an approval for the client device to join the first EDP group.
Clause 10: The method of Clause 8, wherein, in response to determining that the storage limit of the client device does not meet the minimum storage size requirement of the first EDP group, the EDP group response frame comprises at least one of: a rejection for the client device to join the first EDP group, or an assignment of the client device to a second EDP group with a larger epoch interval than the first EDP group.
Clause 11: The method of Clause 1, wherein the method further comprises: prior to receiving the first AID assignment frame, transmitting, to the AP, a request frame for an AID list, the request comprising at least one of: the storage limit of the client device for storing AIDs, or a defined time limit for when the client device can store an AID list update.
Clause 12: The method of Clause 9, wherein: the AP does not receive a second AID assignment response frame to the second AID assignment frame within a defined time limit, in response to missing the second AID assignment response frame, the AP assigns the client device to a second EDP group with a larger epoch interval than the first EDP group.
Clause 13: The method of Clause 12, wherein, upon receiving a second AID assignment response frame indicating successful storage of the revised list, the AP assigns the client device to the first EDP group.
Clause 14: The method of Clause 1, wherein the first AID assignment frame comprises a unicast protected action frame.
Clause 15: A system of a client device, comprising: one or more computer processors; and one or more memories collectively containing one or more programs, which, when executed by the one or more computer processors, perform an operation, the operation comprising: receiving, by a client device from an access point (AP), a first AID assignment frame comprising at least one of: a list of associated identifiers (AIDs) assigned to the client device for use in one or more subsequent epochs, or a start-epoch indicating a first epoch where the assigned AIDs to be applied; determining that a number of the assigned AIDs within the list exceeds a storage limit of the client device; in response to the determination, transmitting, to the AP, a first AID assignment response frame comprising a first status code indicating a failure of storing the list by the client device; and receiving, from the AP, a second AID assignment frame comprising a revised list with a reduced number of AIDs assigned to the client device.

Clause 16: The system of Clause 15, wherein the first AID assignment response frame further comprises the storage limit of the client device, and the reduced number of AIDs falls below or is equal to the storage limit.

Clause 17: The system of Clause 16, wherein the operation further comprises transmitting, to the AP, a second AID assignment response frame comprising a second status code indicating a success of storing the revised list by the client device.

Clause 18: The system of Clause 15, wherein the operation further comprises: storing, by the client device, the list of AIDs up to a storage limit of the client device; and transmitting, to the AP, a second AID assignment response frame comprising at least one of: a second status code indicating partial storage, or a number of AIDs that have been stored by the client device.

Clause 19: The system of Clause 15, wherein the operation further comprises: receiving, by the client device from the AP, a third AID assignment frame at a first time, the third AID assignment frame comprising at least one of: a second list of associated identifiers (AIDs) assigned to the client device for use in one or more epochs, or a start-epoch indicating a first epoch where assigned AIDs within the second list to be applied; determining that the start-epoch within the third AID assignment frame is beyond a predefined time limit; and in response to the determination, transmitting, to the AP, a second AID assignment response frame comprising a second status code requesting the second list to be resent at a second time, wherein the second time is a later time than the first time.

Clause 20: One or more non-transitory computer-readable media containing, in any combination, computer program code that, when executed by a computer system, performs an operation comprising: receiving, by a client device from an access point (AP), a first AID assignment frame comprising at least one of: a list of associated identifiers (AIDs) assigned to the client device for use in one or more subsequent epochs, or a start-epoch indicating a first epoch where the assigned AIDs to be applied; determining that a number of the assigned AIDs within the list exceeds a storage limit of the client device; in response to the determination, transmitting, to the AP, a first AID assignment response frame comprising a first status code indicating a failure of storing the list by the client device; and receiving, from the AP, a second AID assignment frame comprising a revised list with a reduced number of AIDs assigned to the client device.

We claim:

1. A method, comprising:
establishing, by a wireless access point (AP), a wireless communications link between the AP and a wireless station, wherein establishing the wireless communications link comprises assigning the wireless station to an Enhanced Data Privacy (EDP) group, the EDP group associated with timing information for rotating wireless frame anonymization parameters at epoch transitions;
generating, by the AP, a list of N association identifiers (AIDs) for the wireless station, each of the N AIDs to be used in a corresponding epoch of N epochs associated with the EDP group;
transmitting to the wireless station in a protected wireless frame, information indicating the list of N AIDs for the wireless station;
receiving from the wireless station a response frame to the protected wireless frame, wherein the response frame includes a status code indicating whether the wireless station successfully stored at least a portion of the list of N AIDs; and
maintaining, by the AP, the wireless communications link with the wireless station based at least in part on the timing information for randomized MAC address rotation for the EDP group, and including using each AID in the list of N AIDs during corresponding epochs.

2. The method of claim 1, further comprising providing, by the AP, a first communication indicating that the AP supports a randomized Media Access Control (MAC) address rotation management protocol.

3. The method of claim 1, further comprising receiving, from the wireless station, an AID storage capability parameter indicating a maximum storage for the list of N AIDs.

4. The method of claim 1, further comprising:
if the status code indicates a failure, generating, by the AP, a second list of N association identifiers (AIDs) for the wireless station, each of the N AIDs to be used in a corresponding epoch of N epochs associated with the EDP group; and
transmitting to the wireless station in a protected wireless frame, information indicating the second list of N AIDs for the wireless station.

5. The method of claim 1, further comprising receiving, by the AP, a wireless frame indicating a request by the wireless station for a new list of N AIDs.

6. The method of claim 1, wherein the status code indicates acceptance of the list of N AIDs by the wireless station.

7. The method of claim 1, wherein the status code indicates storage, by the wireless station, of a portion of the list of N AIDs.

8. The method of claim 1, wherein the status code indicates that the list of N AIDs is too large for the wireless station.

9. A wireless access point (AP) comprising:
at least one memory element for storing data; and
at least one processor for executing instructions associated with the data, wherein executing the instructions causes a wireless station to perform operations, comprising:
establishing a wireless communications link between the AP and a wireless station, wherein establishing the wireless communications link comprises assigning the wireless station to an Enhanced Data Privacy (EDP) group, the EDP group associated with timing information for rotating wireless frame anonymization parameters at epoch transitions;
generating, by the AP, a list of N association identifiers (AIDs) for the wireless station, each of the N AIDs to be used in a corresponding epoch of N epochs associated with the EDP group;
transmitting to the wireless station in a protected wireless frame, information indicating the list of N AIDs for the wireless station;
receiving from the wireless station a response frame to the protected wireless frame, wherein the response frame includes a status code indicating whether the wireless station successfully stored at least a portion of the list of N AIDs; and
maintaining, by the AP, the wireless communications link with the wireless station based at least in part on the timing information for randomized MAC address rotation for the EDP group, including using each AID in the list of N AIDs during corresponding epochs.

10. The wireless AP of claim 9, the operations further comprising providing, by the AP, a first communication indicating that the AP supports a randomized Media Access Control (MAC) address rotation management protocol.

11. The wireless AP of claim 9, the operations further comprising receiving, from the wireless station, an AID storage capability parameter indicating a maximum storage for the list of N AIDs.

12. The wireless AP of claim 9, the operations further comprising:
if the status code indicates a failure, generating, by the AP, a second list of N association identifiers (AIDs) for the wireless station, each of the N AIDs to be used in a corresponding epoch of N epochs associated with the EDP group; and
transmitting to the wireless station in a protected wireless frame, information indicating the second list of N AIDs for the wireless station.

13. The wireless AP of claim 9, the operations further comprising receiving, by the AP, a wireless frame indicating a request by the wireless station for a new list of N AIDs.

14. The wireless AP of claim 9, wherein the status code indicates acceptance of the list of N AIDs by the wireless station.

15. The wireless AP of claim 9, wherein the status code indicates storage, by the wireless station, of a portion of the list of N AIDs.

16. The wireless AP of claim 9, wherein the status code indicates that the list of N AIDs is too large for the wireless station.

17. A non-transitory computer readable storage medium comprising instructions that when executed configure one or more processors of a wireless access point (AP) to perform operations comprising:
establishing a wireless communications link between the AP and a wireless station, wherein establishing the wireless communications link comprises assigning the wireless station to an Enhanced Data Privacy (EDP) group, the EDP group associated with timing information for rotating wireless frame anonymization parameters at epoch transitions;
generating, by the AP, a list of N association identifiers (AIDs) for the wireless station, each of the N AIDs to be used in a corresponding epoch of N epochs associated with the EDP group;
transmitting to the wireless station in a protected wireless frame, information indicating the list of N AIDs for the wireless station;
receiving from the wireless station a response frame to the protected wireless frame, wherein the response frame includes a status code indicating whether the wireless station successfully stored at least a portion of the list of N AIDs; and
maintaining, by the AP, the wireless communications link with the wireless station based at least in part on the timing information for randomized MAC address rotation for the EDP group, including using each AID in the list of N AIDs during corresponding epochs.

18. The non-transitory computer readable storage medium of claim 17, the operations further comprising providing, by the AP, a first communication indicating that the AP supports a randomized Media Access Control (MAC) address rotation management protocol.

19. The non-transitory computer readable storage medium of claim 17, the operations further comprising receiving, from the wireless station, an AID storage capability parameter indicating a maximum storage for the list of N AIDs.

20. The non-transitory computer readable storage medium of claim 17, the operations further comprising:
if the status code indicates a failure, generating, by the AP, a second list of N association identifiers (AIDs) for the wireless station, each of the N AIDs to be used in a corresponding epoch of N epochs associated with the EDP group; and
transmitting to the wireless station in a protected wireless frame, information indicating the second list of N AIDs for the wireless station.
